(19) United States
(12) Patent Application Publication
(10) Pub. No.: US 2014/0253412 A1
(43) Pub. Date: Sep. 11, 2014

(54) Method for Displaying Confidential Data on an Auxiliary Device

(71) Applicants: Andrew Blaich, San Francisco, CA (US); Jeffrey Forristal, San Francisco, CA (US)

(72) Inventors: Andrew Blaich, San Francisco, CA (US); Jeffrey Forristal, San Francisco, CA (US)

(73) Assignee: Bluebox Security Inc., San Francisco, CA (US)

(21) Appl. No.: 14/203,794

(22) Filed: Mar. 11, 2014

Related U.S. Application Data
(60) Provisional application No. 61/776,675, filed on Mar. 11, 2013.

(51) Int. Cl. G06F 3/14

(52) U.S. Cl. CPC G06F 3/14
USPC 345/1.2

(57) ABSTRACT

A computer-implemented process for outputting sensitive data to a user, so that the data is perceivable in a manner that is more private than displaying the data on a primary computer screen is provided. The method is implemented on a computing system and includes receiving a plurality of data for display on a display on the computing system, determining what is sensitive data from the plurality of data, and transmitting that which as been determined to be sensitive data apart from the plurality of data to an auxiliary system. In this manner, sensitive data can be perceived privately and as desired or programmed, ordinary data can be displayed on a primary visual device.

### CROSS-REFERENCES TO RELATED APPLICATIONS

The present application is a continuation of (provisional) Application No. 61/776,675; filed on Mar. 11, 2013, the full disclosures of which is incorporated herein by reference.

### FIELD OF THE INVENTION

The present invention relates to methods and apparatus for outputting secure, confidential and or private data to a user. More particularly, the present invention relates to methods for making available, such as by displaying a visual representation of such data, upon an auxiliary or secondary device appropriate for the data.

### BACKGROUND OF THE INVENTION

From the first time that a sheet of paper was held up to be read, there has existed the third party who either out of curiosity or to glean information therefrom, has looked over the shoulder of the reader onto the page. Similarly, since the advent of the personal computing device, including such instruments as the desk top computer, the laptop or notebook computer, tablets, smart phones and readers, third parties have had the inclination to look onto the screens of the user, again either out of curiosity or for more nefarious reasons. This type of visual eavesdropping over the shoulder of an unknowing user has been termed “shoulder surfing.”

It is well understood that if a user of a computing device is working on confidential information, or the like, some techniques may be used to help restrict the display of such information. One solution involves the application of “privacy screens” to the computing device display, thereby narrowing the angle of viewing of the display. There have been polarizing screens, and other similar devices, for some time that permit the user of a screen to limit the viewing of the screen to the person directly in front thereof; viewers from the side typically see only a darkened screen and are unable to read the contents of the screen. While blocking the view of third parties such screens also make non-direct viewing of the display more difficult to the user who is not perfectly positioned in front of the device screen (that is, the primary user).

Various problems exist with this solution including that that users often do not like to have their field of view of their devices restricted. Instead, users would likely desire, for comfort and convenience, to view their displays from numerous positions and with their displays in a number of orientations, whether a desktop display, smart-phone, laptop, or the like. Accordingly, restricting a field of view using such a screen is not desirable. A solution, to this complaint, would be to only use such screens during times when sensitive information is being read on the screen. However, even the temporary use of such screens when accessing “sensitive” data is undesirable, as the user must then keep the screen handy for such times and then the use of the screen would be an advertisement to third party observers that the user is now working on sensitive data. Other solutions include decisions or directives to not work on private or sensitive matters in public spaces; which would cause such opportune work situations, as long rides on public conveyances, to be wasted time.

The present invention is derived from the recognition that when a user uses a computing device in the presence of other individuals, other individuals can and do glance at the computing device to see what the primary user is doing. Further there has been an understanding that the use of screens, as noted above, is inconvenient and can be uncomfortable to use. There is therefore a need for a solution to the problems noted herein that allows for security, without calling attention to the fact that sensitive information is being reviewed while providing a comfortable work situation and convenience to the user.

Objects and advantages of the present invention will become apparent as the description proceeds.

### SUMMARY OF THE INVENTION

In accordance with the present invention, a method for sending data from a primary device to an auxiliary display implemented on a computing system, to allow the more private viewing of the data, is provided. In one embodiment, the method comprises the steps of receiving in the computing system a plurality of data for display on a primary display associated with the computing system, determining particular data which requires sensitive treatment from the plurality of data displayed, transmitting the particular data to an auxiliary display for display to the user alone. In some embodiments, the auxiliary display on which the sensitive data is displayed is on a second device in electronic communication with the computing system. It will be understood that in the use of the invention the second device can include one or more display devices and/or one or more screens and can be any one or more of a laptop computer, a smartphone, a tablet computer, a smart watch, a reader device, a heads up display device, an eyeglass display and a desktop computer. In embodiments of the present invention, the original display can be used to show the plurality of data excluding the particular data to the user if it is possible to separate that data in this way.

We have found that the data can be separated into secure and regular data responsive to an analysis of the metadata associated with the plurality of data. Further the particular data can be separated from the plurality of data in response to a previously selected analysis of the plurality of data. The analysis can include: determining in the computing system, types of data associated with the plurality of data and subsequently determining the particular data from the plurality of data in response to the types of data as determined. In embodiments the types of data are selected from the following groups: a personal identification number, a social security number, a password, a financial account information, a monetary balance, and financial information. In addition a user input regarding what the system should look for can be used in determining and separating the particular data, from the plurality of data.

In an embodiment of the present invention the method used can further include the following steps: receiving in the computing system, a plurality of additional data for display on the original display screen associated with the computing system; then determining additional particular or sensitive data from the plurality of additional data and in response to a user input transmitting the additional particular or sensitive data to the auxiliary or secondary display for more private display thereon. In embodiments of this method, the plurality of data can be transmitted using an encryption mechanism and the particular or sensitive data is culled in response to the encryption mechanism.

In the methods of practicing the invention, the transmission of the additional particular or sensitive data from the plurality of additional data to an auxiliary display includes transmitting using an interface. As will be known by persons having ordinary skill in the art the interface can be any type of transmitting interface including but not limited to Wifi, Bluetooth, Ethernet, Infrared, Near-Field Communication, a proprietary protocol format over a radio frequency, ZigBee, and Z-wave.

In another embodiment, the method for sending data from a primary device to an auxiliary display in electronic communication with the primary device comprising the steps of receiving a plurality of data for display on a primary display, determining the particular data from the plurality of data, transmitting the particular data apart from the plurality of data to the auxiliary display such that the auxiliary display can be seen on one or more second display devices, of any type as noted above. In addition the plurality of data excluding the particular data sent to the second display can continue to be displayed to the user on the first screen.

A more detailed explanation of the invention is provided in the following description and claims and is illustrated in the accompanying drawings.

### BRIEF DESCRIPTION OF THE DRAWINGS

FIG. 1 is a representation of a system using the method of the present invention;

FIG. 2 is a flow chart of the functionality of the client device; and

FIG. 3 is a flow chart of the functionality of the auxiliary display device.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

While the present invention refers to displays and display devices it will be understood that devices that have display screens and devices that project a display either to a screen, to a lens or in other ways, and devices that provide information in any form, such that information, including data, images and other information can be utilized by the device user are included in the scope of the present invention. Display in these situations is meant to include any means by which one device provides information to a user. To this extent, it will be seen that information provided audibly, or by any means that is understandable to the user, is also within the novel scope of the present invention.

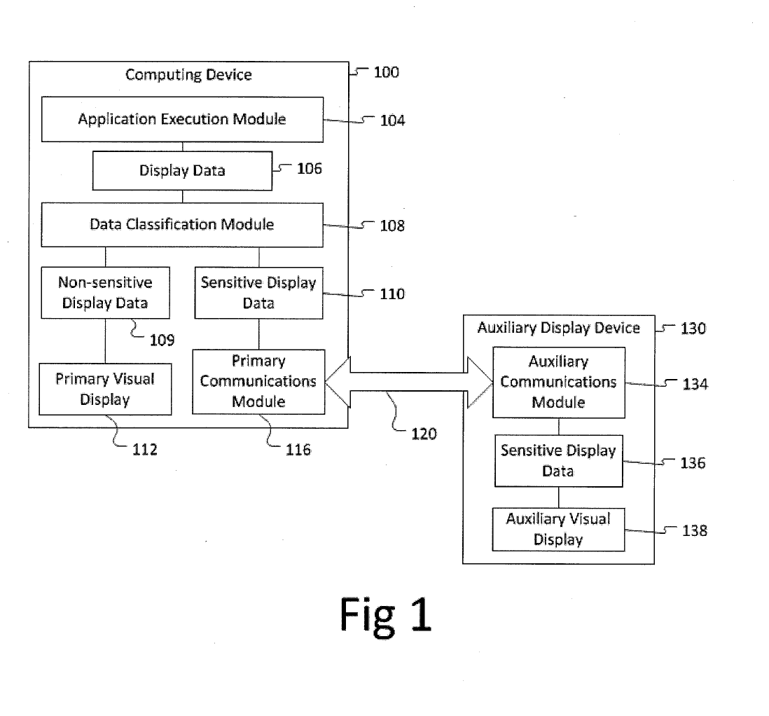

Referring to FIG. 1, client device 100 embodies an application execution module 104, a data classification module 108, a primary visual display 112, and a primary communications module 116 capable of sending and receiving communications 120. The primary communications module 116 can communicate using one or more methods, including, but not limited to, WiFi, Bluetooth, Ethernet, Zigbee, a proprietary wireless radio signal format, a proprietary wired signal format, or the like. Persons having ordinary skill in the art will recognize other ways a communications module can transmit a communications within the present invention, without departing from the novel scope thereof. An auxiliary display device 130 embodies an auxiliary communications module 134, capable of sending and receiving communications 120, and an auxiliary visual display 138. The auxiliary communications module 134 implements one or more of the same communications methods implemented in the primary communications module 116, thus allowing the auxiliary communications module 134 and primary communications module 116 to effectively communicate by one or more means.

Application execution module 104 operates to execute a software application or other pre-configured logic that includes the production of a plurality of display data 106 to be displayed to the user via primary visual display 112. The display data 106 can include textual or graphical data to be shown to the user, and can include meta-data regarding the nature of the textual or graphical data including indicator that the data is a password, indicator that the data is sensitive, indicator that the data is a social security number, indicator that the data is financial information, indicator that the data is personal piece of information, or the like. Persons having ordinary skill in the art will understand that there are a plurality of other means for meta-data to represent or indicate certain aspects regarding the data that can be applied herein without departing from the novel scope of the present invention.

When the application execution module 104 operated to display the plurality of display data 106 to the user of the computing device 100, the plurality of display data 106 is provided to the data classification module 108. The data classification module 108 contains pre-determined logic to process the plurality of display data 106 and determine which subsets of display data 106 contain non-sensitive display data 109 and which subsets of display data 106 contain sensitive display data 110. For example, data containing social security numbers, PIN codes, personally identifiable information, passwords, bank account numbers, financial statements, security classified information, healthcare information, information regarding a person of minor age, socially-recognized private information, information where the user desires discretion, SMS messages, email messages, telephone numbers, or the like can be considered sensitive information. Persons having ordinary skill in the art will understand that there are additional types of data that can be considered to be sensitive, which are included in the scope of the present invention.

For non-sensitive display data 109, the data classification module 108 provides the non-sensitive display data 109 to the primary visual display 112, where it is shown to the user. For the sensitive display data 110, the data classification module 108 provides the sensitive display data 110 to the primary communications module 116. The primary communications module 116 sends communications 120 to the auxiliary communications module 134 of the auxiliary display device 130. Upon receiving the communications 120, the auxiliary display device 130 transforms the communications into sensitive display data 136. The sensitive display data 136 on the auxiliary display device 130 represents the sensitive display data 110 on the computing device 110. The auxiliary display device 130 provides the sensitive display data 136 to the auxiliary visual display 138, where it is shown to the user. It will be understood by persons having ordinary skill in the art that the user of the device can override the method to cause the client device 100 to send information that the user believes is sensitive, in spite of the programming not making such a determination, to the auxiliary display device by manipulation of a keyboard, mouse or other data manipulation means (not shown), so that the information can be reviewed in privacy.

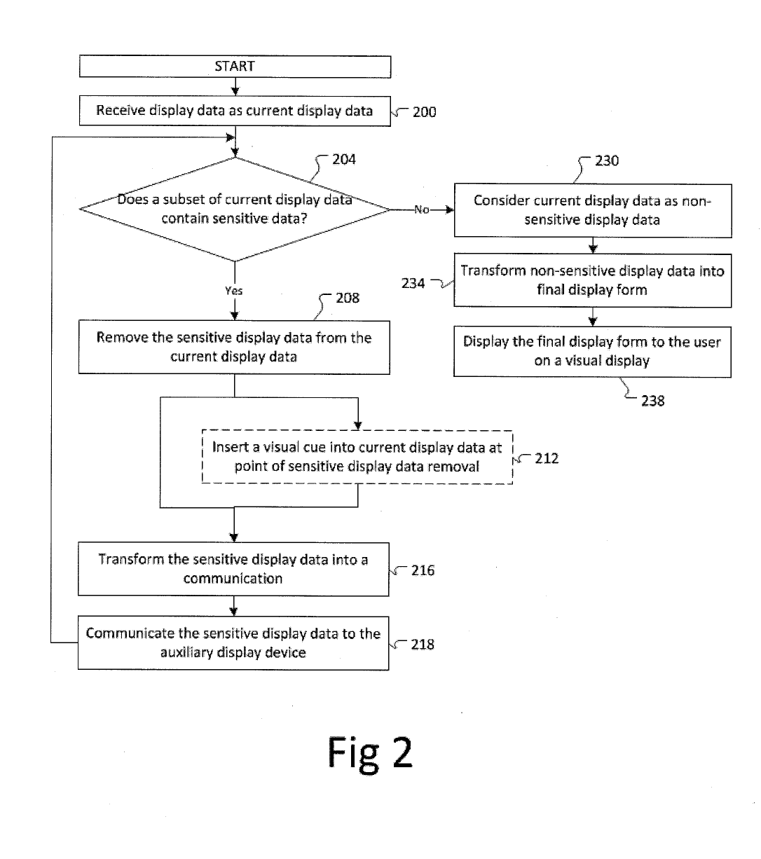

Referring to FIG. 2, a method is illustrated that represents the method performed on the client device 100 (FIG. 1). The data classification module 108 (FIG. 1) receives 200 display data and considers it the current display data. A determination 204 is made as to whether the current display data contains sensitive display data, if so, the sensitive display data is removed 208 from the current display data. Optionally, an alternate display data can be inserted 212 into the current display data at the point of sensitive display data removal. The alternate display data can consist of one or more of: a visual cue, a textual notice, a graphical notice, or the like. The purpose of the alternate display data is to visually inform the user that display data was considered sensitive and will be displayed on the auxiliary device. Persons having ordinary skill in the art will recognize additional ways an alternate display data can be constructed without departing from the novel scope of the present invention. Finally, the sensitive display data is transformed 216 into a communication, the communication is then communicated 218 to the auxiliary display device 130 (FIG. 1), and the process then repeats itself to determine 204 if further sensitive display data is present in the current display data. The transformation 216 of the sensitive display data into communication uses industry standard methods to construct a communication representation from a logical data representation. For example, communication protocol data may be added, CRC codes may be constructed, or the like. Persons having ordinary skill in the art will recognize that there are many ways a communication can be constructed to represent logical data, without departing from the novel scope of the present invention.

When there is no further sensitive data in the current display data 204, the current display data is considered 230 to be the non-sensitive display data. The non-sensitive display data is transformed 234 into a final display form, and the final display form is shown 238 to the user on a visual display 112 (FIG. 1). The transformation 234 of non-sensitive display data into final display form uses industry standard methods to construct visual display representation from a logical data representation. For example, the logical data representation can be transformed into display pixels using various methods of compositing, shading, coloring, rasterisation, ray tracing, rendering, or the like. Persons having ordinary skill in the art will recognize the many ways display data can be transformed into a display form appropriate for visual display without departing from the novel scope of the present invention.

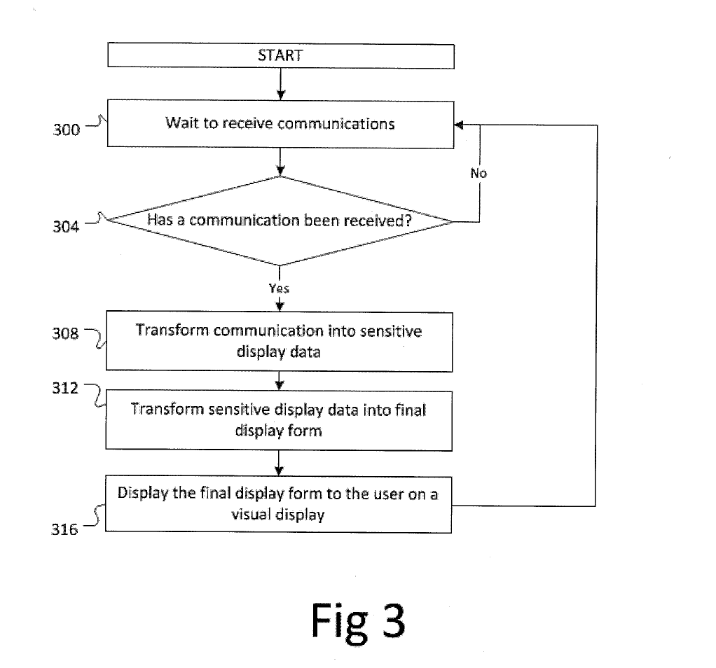

Referring now to FIG. 3, a method is illustrated that represents the method performed on the auxiliary display device 130 (FIG. 1). The auxiliary display device 130 (FIG. 1) waits 300 for a communication to be received by the auxiliary communications module 134 (FIG. 1). If a communications has been received 304, the communications are transformed 308 into a sensitive display data, the sensitive display data is transformed 312 into a final display form, and the final display form is shown 316 to the user on a visual display 138 (FIG. 1). The process then repeats to wait 300 to receive the next communication. The method queries 304 to determine if a communication has been received, and if it has not, then the process repeats, in a loop, until a communication is received.

The transformation 308 of the communication into the sensitive display data uses industry standard methods to construct a logical data representation from a communication representation. For example, communication protocol data may be removed; CRC codes may be consulted to detect communications errors, or the like. Persons having ordinary skill in the art will recognize the many ways a communication can be transformed into a logical data representation, all of which can be included herein without departing from the novel scope of the present invention. The transformation 312 of sensitive display data into final display form uses industry standard methods to construct visual display representation from a logical data representation. For example, the logical data representation can be transformed into display pixels using various methods of compositing, shading, coloring, rasterisation, ray tracing, rendering, or the like. A person having ordinary skill in the art will recognize the many ways display data can be transformed into a display form appropriate for visual display.

In various embodiments the display of such secure, confidential, and/or private data may be coordinated via a communications mechanism between the computing device and the external secondary device, including display devices.

In various embodiments, a number of devices may be used to provide the external secondary display device. For example, the general marketplace now contains a large number of smaller, personal computing devices of varying form factors. These include “heads-up displays”, which embody a visual display and computing circuitry that the user wears on the head. One example is Google Project Glass, which is marketed as an augmented reality head-mounted display that can display information in smartphone-like format. Another type of device is a computing device designed in a wrist-watch form. Current examples of such a device include the Sony SmartWatch or the Pebble watch which both include touch screens and Bluetooth communications radios. There is however, no limitation implied by this list as new devices are being developed and can be used to provide the displays necessary to the present invention.

The advantages of using such personal computing devices as secondary or private viewing devices, includes allowing the user to view sensitive information in a manner that is more difficult for other individuals to see, despite being in the presence of the device. For example, it is difficult for nearby individuals to casually witness what is exactly being projected onto the small display screen of a head-mounted display. Accordingly, it is much more difficult to “visually eavesdrop” on the visual displays of these personal computing devices, thereby offering mores security to the information displayed.

In various embodiments, types of sensitive information (secure, confidential/private data) may depend upon user context. Some examples of data that could be considered sensitive are: authentication passwords, credit card/financial data, health care records/data, confidential corporate information, temporary PIN codes, legally privileged information, private socially contested photographs; or the like. It will be understood that this list is exemplary and not meant to be limiting.

The present invention includes, in most embodiments, the use of a primary computing device, such as a desktop computer, laptop, smartphone, tablet, etc. including a central processing unit, memory, persistent and non-persistent storage, a communication module, and a primary visual display; and a secondary personal computing device, including a personal visual display, a communication module, and necessary circuitry to display visual data.

In various embodiments, the primary computing device execution logic, determines whether sensitive data is about to be displayed on the primary computing device. If so, the primary computing device uses the communication module to provide the sensitive data for display on the personal visual display. Accordingly, in various embodiments, the sensitive data is effectively re-routed from the primary computing device to the personal device display, such that fewer surrounding individuals can see the sensitive data. In most embodiments, the user of the device can also exercise command decision and move sensitive information manually to the personal device display using the elements and programming of the present invention.

In various embodiments, the communication modules located in the primary computing device and personal computing device can incorporate any number of communication protocols and technology such as Wifi, Bluetooth, Ethernet, ZigBee, Near-Field Contact (NFC), or the like; the communication modules may incorporate a proprietary communication protocol built on generalized standard technology such as radio frequency, infrared light, or electrical transmission over a physical wire; and other communication modules may incorporate a combination of wired and wireless communications. In light of the present disclosure, one of ordinary skill in the art will recognize many other ways two communication modules can be made to communicate that are within the novel scope of the present invention.

In various embodiments, the execution logic on the primary and personal computing devices can be in the form of software, firmware, or static logic in hardware executed upon one or more processing units. Further, there are multiple variations on how the execution logic on the primary computing device can determine whether a specific set of data is deemed private/confidential/secure and warrants personal display. One variation involves prompting/asking the user whether they want to display the data on their personal device display. Another variation involves allowing the user to manually explicitly specify when they want the data to be displayed on their personal device display. A third variation involves taking context clues about the data, such as identifying an explicit password field in a web browser login form, and automatically displaying that data on the personal device display or leveraging key words contained within the data to indicate the context for the data. A fourth variation involves a prescribed set of conditions and instructions, also known as a “configuration” or “policy”, that would direct the execution logic on how to identify the correct type of data that should be displayed on the personal device display. A fifth variation involves an external software application or external execution logic explicitly informing the invention execution logic that received data is intended to be displayed on the personal device display. Other variations may include combinations of variations noted.

According to the present invention, a primary computing device apparatus includes a central processing unit, a primary visual display, a communications module, and one or more processing units capable of executing one or more programs stored in a memory. A personal computing device apparatus includes a personal visual display, a communications module, and necessary circuitry to operation the communications module and one or more processing units capable of executing one or more programs stored in a memory. The primary computing device processing unit (for example the execution logic) may perform the following steps: receive data to display on the primary visual display; determine whether the data is considered sensitive for visual display; transmit the sensitive data via the communication module to the personal computing device for display on the personal visual display. The personal computing device may perform the following steps: receive sensitive data via the communication module, display the information on the personal visual display.

While the following list is meant to be exemplary, persons having ordinary skill in the art will understand that other devices and or combinations of other devices and/or those listed herein, can be used for the implementation of the invention of the present disclosure without departing from the novel scope thereof. It will be understood that examples of the primary computing device could be: desktop computer, laptop, smartphone, tablet, or the like. The personal computing device apparatus could include of a computing device head-mounted display. An example would be Google Project Glass. The personal computing device apparatus could include of a computing device wearable on the wrist of the human body. An example would be Sony SmartWatch, Pebble, among others, as will be understood by persons having ordinary skill in the art. The communications module can embody one or more of the following communication technologies: Wifi, Bluetooth, Ethernet, Infrared, Near-Field Communication, a proprietary protocol format over a radio frequency, a proprietary protocol format over an electrically-carrying plurality of wires, ZigBee.

In the operation of the present invention, data considered sensitive data may include data that is secret, private, or confidential. Examples include authentication passwords, credit card/financial data, health care records/data, confidential corporate information, temporary PIN codes, legally privileged information, and private socially contested photographs, SMS messages, e-mail messages, telephone number, and the like.

Determination as to whether the data is sensitive for display, can include the steps of: prompting the user by displaying a visual prompt indicator on the primary computing device display, receiving input from the user, and translating the input to make a determination. For example, showing the user a visual choice of “Display personal” and “Display primary”, such that the user's choice indicates the determination of where to display.

Determination as to whether the data is considered sensitive for display can involve the steps of: using the last provided explicit determination provided by the user as a template for future determinations. The last provided explicit determination provided by the user would be received through an input mechanism prior to the point of determination.

Determination as to whether the data is considered sensitive for display can involve the steps of: identifying the context and supporting information related to the data, and using the context and supporting information to automatically determine if the data is sensitive. An example would be the password input field in a web browser authentication form. The use of a password input field would provide context that the data in the field is a password, and that passwords are considered a secure piece of data. Another example would be encrypted data, such as an encrypted document or encrypted email message. The presence of encryption on the data would provide context that the data in the field is restricted for dissemination, warranting a confidential determination. Another example would be the presence of a plurality of static or user-definable key words within the data, such as the words “Confidential” or “Top Secret”. The presence of a specific key word indicates a personal display determination should be made.

Determination as to whether the data is considered sensitive for display can involve the steps of: accessing a set of data containing identification steps and directions, known as the “Policy” or “Configuration”; interpreting and executing the identification steps and directions to arrive at a determination specified by the “Policy” or “Configuration”.

Determination as to whether the data is considered sensitive for display can involve the steps of: using an external execution logic entity to provide a determination for the data.

Various embodiments may be implemented upon a hand-held device such as a smart-phone or other devices as known to persons having ordinary skill in the art. For example, such devices can be an Apple iPhone or iPad, Samsung Galaxy devices, an Android-based tablet, Ultrabook, laptop, and others. These devices typically include program memory, a processor, a wireless communications channel, and other operational elements. Additionally, secure viewing devices can be implemented upon a device such as a smart watch, head-up display, and others. These devices typically include program memory, a processor, a wireless communication channel, and other operational elements. Persons having ordinary skill in the art will understand that at minimum an additional screen or element that permits a user to read or view data is necessary to the present invention and a plethora of such devices exist or are being created that can be used without departing from the novel scope of the present invention.

Although an illustrative embodiment of the invention has been shown and described, it is to be understood that various modifications and substitutions may be made by those skilled in the art without departing from the novel spirit and scope of the invention.

What is claimed is:

1. A method for sending data from a primary device to an auxiliary display, implemented on a computing system, the method comprising the steps of:
receiving in the computing system, a plurality of data for display on a primary display associated with the computing system;
determining, in the computing system, particular data from the plurality of data;
transmitting from the computing system, the particular data from the plurality of data to an auxiliary display for display to the user.

2. The method of claim 1, wherein the auxiliary display is on a second device in electronic communication with the computing system.

3. The method of claim 2, wherein the second device can include one or more display devices.

4. The method of claim 3, wherein the second device is one of: a laptop computer, a smart phone, a tablet computer, a smart watch, a reader device, a heads up display device, an eyeglass display, a desktop computer.

5. The method of claim 1 further comprising the step of displaying on a display associated with the computing system, the plurality of data excluding the particular data to the user.

6. The method of claim 1 wherein determining in the computing system, particular data from the plurality of data is responsive to an analysis of the metadata associated with the plurality of data.

7. The method of claim 1 wherein determining in the computing system, particular data from the plurality of data is in response to a previously selected analysis of the plurality of data.

8. The method of claim 1 wherein determining, in the computing system, particular data from the plurality of data comprises:
determining in the computing system, types of data associated with the plurality of data; and
subsequently determining the particular data from the plurality of data in response to the types of data as determined.

9. The method of claim 8 wherein the types of data are selected from a group comprising: a personal identification number, a social security number, a password, a financial account information, a monetary balance, and financial information.

10. The method of claim 1 further comprising the step of receiving in the computing system, a user input wherein determining the particular data, from the plurality of data, is in response to the user input.

11. The method of claim 10 further comprising the steps of:
receiving in the computing system, a plurality of additional data for display on a display associated with the computing system;
determining in the computing system, additional particular data from the plurality of additional data, in response to the user input; and
transmitting from the computing system, the additional particular data to the auxiliary display for display thereon.

12. The method of claim 1 wherein the plurality of data is transmitted using an encryption mechanism; and wherein determining in the computing system, the particular data from the plurality of data is in response to the encryption mechanism.

13. The method of claim 11 wherein transmitting, from the computing system, the additional particular data from the plurality of additional data to an auxiliary display for display includes transmitting using an interface; and wherein the interface is selected from a group comprising interfaces transmitting via: Wifi, Bluetooth, Ethernet, Infrared, Near-Field Communication, a proprietary protocol format over a radio frequency, ZigBee, and Z-wave.

14. A method for sending data from a primary device to an auxiliary device in electronic communication with the primary device, implemented on a computing system, the method comprising the steps of:
receiving in the computing system, a plurality of data for display on a primary display associated with the computing system;
determining in the computing system, the particular data from the plurality of data;
transmitting from the computing system, the particular data from the plurality of data to the auxiliary device for delivery to the user; and,
wherein the particular data can be realized on one or more second devices.

15. The method of claim 14, wherein the one or more second devices are one of: a laptop computer, a smart phone, a tablet computer, a smart watch, a reader device, a speaker and a desktop computer.

16. The method of claim 14 further comprising the step of displaying on a display associated with the computing system, the plurality of data excluding the particular data to the user.

17. The method of claim 14 wherein determining in the computer system, the particular data from the plurality of data is responsive to an analysis of the metadata associated with the plurality of data.

18. The method of claim 14 wherein determining in the computing system, the particular data from the plurality of data is responsive to a previously selected analysis of the plurality of data.

19. The method of claim 14 wherein determining in the computing system, the particular data from the plurality of data comprises:
determining in the computer system, types of data associated with the plurality of data; and
subsequently determining the particular data from the plurality of data in response to the types of data as determined.

20. The method of claim 14 wherein determination as to whether the data is particular data is made by the user of the user of the computing system while operating the computing system.
